(19) United States
(12) Patent Application Publication
(10) Pub. No.: US 2004/0091030 A1
(43) Pub. Date: May 13, 2004

(54) Process to refurbish cable modem circuitry to comply with DOCSIS 2.0 specification

(76) Inventors: Selim Shlomo Rakib, Cupertino, CA (US); David Watkins James, San Jose, CA (US)

Correspondence Address: RONALD CRAIG FISH, RONALD CRAIG FISH, A LAW CORPORATION, POST OFFICE BOX 2258, MORGAN HILL, CA, 95038, US

(21) Appl. No.: 10/294,657

(22) Filed: Nov. 13, 2002

(51) Int. Cl. H04B 1/38

(52) U.S. Cl. 375/222

(57) ABSTRACT

A process for refurbishing cable modems which are not compliant with DOCSIS 2.0 to create a cable modem which is compliant with DOCSIS 2.0 and which reuses many of the components and circuits of the non compliant target modem in the circuitry which is compliant with DOCSIS 2.0. A replacement circuit board is mounted on the PCB of the target modem and connected to predetermined points to replace the functionality that is not DOCSIS 2.0 compliant with functionality that is.

### BACKGROUND OF THE INVENTION

There are a large number of cable modems that have been purchased by cable operators which are designed to operate in proprietary time division multiple access (TDMA) or synchronous code division multiple access (SCDMA)schemes. There also a large number of older DOCSIS 1.0 and 1.1 compliant cable modems which have been purchased by cable system operators for use by their customers, but these older cable modems do not comply with the emerging DOCSIS 2.0 standard being developed by an industry consortium led by Cable Labs. Motorola, Terayon, Com 21 and others manufacture these legacy TDMA, SCDMA, DOCSIS 1.0 and 1.1 cable modems (which are collectively referred to herein as the target modems). These target modems represent a large investment by the cable operators that they would like to recoup as much as possible to reduce their capital outlay expenditures to upgrade to DOCSIS 2.0 compliant cable modems.

DOCSIS 2.0 will soon become the industry standard because it allows higher throughput and provides better forward error correction capabilities than DOCSIS 1.0 and 1.1 and some of the prior art proprietary schemes. For example, DOCSIS 2.0 provides a 30 megabits per second upstream throughput whereas DOCSIS 1.0 and 1.1 maximum upstream capacity is only 10 megabits per second. This is because the maximum symbol rate in DOCSIS 1.0 and 1.1 is 256 megasymbols per second with 4 bits per symbol with strictly time division multiple access multiplexing so only one cable modem can be transmitting during any particular minislot. In contrast, in DOCSIS 2.0 cable modems allows synchronous code division mulitplexing so multiple cable modems can transmit simultaneously and provide a maximum symbol rate of 512 megasymbols per second. Further, the constellation is QAM 64 and QAM 128 in DOCSIS 2.0. DOCSIS 2.0 also provides better equalization, and better forward error correction by using longer code blocks for block codes, interleaving to fight burst noise, Trellis code modulation to add a redundant bit to each constellation point with the Trellis code modulation concatenated with the Reed Solomon encoding to add parity bits to each codeword. DOCSIS 1.0 and 1.1 do not have interleaving or Trellis Code Modulation.

Because many of the components and physical structures of these proprietary and DOCSIS 1.0 and 1.1 modems are also used in DOCSIS 2.0 modems, it would be advantageous and approximately a 50% cost savings if these older modems could be refurbished to comply with DOCSIS 2.0 standards.

Thus, a need has arisen for a process to re-use many of the components of the older proprietary cable modems and DOCSIS 1.0 and 1.1 modems and modify the circuitry to make the modems compliant with DOCSIS 2.0.

### SUMMARY OF THE INVENTION

The genus of the invention is defined by a class of processes which all share the common characteristics that:

they reuse many of the components of the older, obsolete modems; and

optionally remove at least the processor and media access control circuits of the obsolete modem; and

substitute a new processor and new media access control circuitry and optionally other circuitry such as a voltage regulator, flash memory and DRAM; and

break the connections on the original printed circuit board of the obsolete modem at locations selected such that signals can be taken from some of the points at which breaks were made and supplied to the new processor and media access control circuits, and signals can be taken from the new processor and media access control circuits and supplied to some of the points at which breaks were made.

### BRIEF DESCRIPTION OF THE DRAWINGS

FIG. 1 is a block diagram of a prior art proprietary SCDMA modem showing the points at which breaks are made in the conductive traces on the printed circuit board in order to connect new DOCSIS 2.0 compliant circuitry.

FIG. 2 shows mechanical mounting of a replacement PCB.

### DETAILED DESCRIPTION OF THE PREFERRED AND ALTERNATIVE EMBODIMENTS

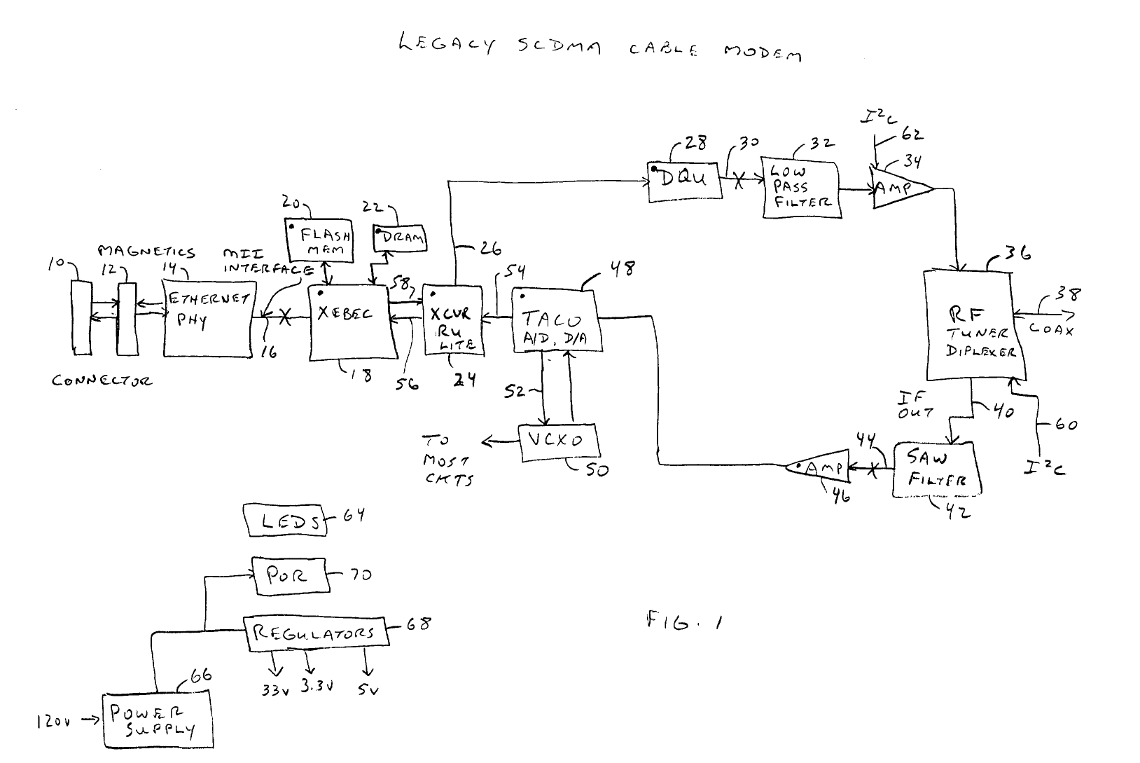

Referring to FIG. 1, there is shown a block diagram of a legacy SCDMA cable modem for purposes of example of how any one of the target modems is converted to a DOCSIS 2.0 compliant cable modem. Block 10 is a connector to connect the modem to an Ethernet local area network (LAN). Block 12 are known magnetic transformers etc. needed for transmission and reception of LAN packets on the physical media of the LAN. Block 12 includes filters, common mode rejection circuitry, terminations to prevent reflections, etc. Block 14 is the conventional Ethernet physical layer (PHY) circuitry and has a standard MII interface 16.

The Ethernet PHY circuitry is coupled by the industry standard MII interface bus 16 to a XEBEC circuit 18. The X on bus 16 shows this as the preferred break point in the circuitry of the cable modem to which the new substitute circuitry that is DOCSIS 2.0 compliant will be coupled so as to leverage the MII interface. If the MII interface is not used, the break point may between the LAN PHY 14 and the magnetics 12. The XEBEC circuit contains a microprocessor and various media access control (MAC) circuits to implement MAC protocols. The XEBEC circuit is coupled to a flash memory chip 20 and a DRAM circuit 22 which are typically 1 megabyte and 2 megabytes in capacity for a Terayon SCDMA legacy cable modem. These memories store the program the microprocessor runs and other data. Typically, these memory sizes are too small for DOCSIS 2.0 use, and since the cost of larger capacity memories is actually less than adding another flash and DRAM and supplementing the address space when the labor is considered, it is preferred to simply remove the flash memory 20 and DRAM 22 and substitute bigger flash memory and DRAM chips on the replacement circuit to be described further below.

A transceiver 24 houses the transmitter and receiver circuitry of the modem that does forward error correction (FEC), spectrum despreading and spreading, equalization, ranging, Trellis code modulation, etc. that are required to generate constellation points and detect and error correct payload data in received constellation points using whatever FEC scheme is being used. The constellation points to be transmitted are output on line 26 as baseband digital data to a digital quadrature upconverter (DQU) 28. The DQU takes the input constellation points and uses them to modulate two quadrature radio frequency (RF) carriers represented by digital samples of the sine and cosine waveforms of a local oscillator at the desired RF or intermediate frequency. Frequency step up may be done in tuner 36 after conversion of the digital representation of the output QAM signal from digital to analog in the DQU circuit 28. The DQU 28 is not re-used when a 6130 replacement circuit (to be described below) is used since the 6130 chip already contains a DQU so DQU 28 is not needed. However, if, for example a custom replacement circuit is fabricated, the DQU function could be left off and the DQU 28 could be re-used. The 6030 replacement circuit (described further below) does not have an on-board DQU, so additional glue logic on the replacement PCB would have to be used to do the DQU function if the DQU 28 is not reused (leveraged).

The RF output signals from the DQU are supplied on line 30 to a low pass filter 32 which eliminates all high frequency alias components generated by the digital-to-analog conversion process in the DQU 28. Elsewhere, usually in the transceiver, there are digital filters which do equalization and pulse shaping filtering. The pulse shaping filter will have a filter characteristic having a Fourier transform equal to the square-root of the raised cosine so as to shape the time domain pulses so as to minimize intersymbol interference (ISI). The X in line 30 indicates that this is the preferred break point which is to be coupled to the new DOCSIS 2.0 compliant circuitry.

The output of the low pass filter 32 is coupled to the input of a power amplifier 34. The power amplifier 34 feed the transmit side input of an RF tuner/diplexer circuit 36 which is coupled to the coaxial cable of the hybrid fiber coaxial cable (HFC) of the cable system operator.

The RF tuner tunes the appropriate channel and filters out unwanted signals and mixes the selected channel down to an intermediate frequency signal on line 40 which is set at the center frequency of a SAW filter 42 which filters out unwanted signals.

The SAW filter outputs a filtered analog signal on line 44 to the input of an amplifier 46. The X in line 44 indicates the preferred point to make a break in the conductive traces of the legacy modem printed circuit board to couple the DOCSIS 2.0 compliant circuitry to be added.

The output of the amplifier is coupled to the input of a TACO chip 48 which contains an analog-to-digital converter and some digital-to-analog converters. The TACO chip does IF sampling to alter the IF frequency down to the baseband at which the transceiver circuit 24 works and outputs the digital sample stream to the transceiver 24 upstream baseband digital sample input. The TACO chip receives a clock signal from a voltage controlled oscillator 50 which generates various timebase signals and is coupled to many of the circuits in the modem. The TACO chip controls the frequency of the VCXO oscillator by recovering the downstream clock and generating clock steering signals on line 53 which synchronize the local oscillator to the master clock signal embedded in the downstream signals sent from the headend and recovered by the TACO chip 48. The digital samples of the received downstream constellation points are supplied via line 54 to the transceiver (RU lite) circuit 24 where they are detected and error corrected and downstream payload data is output on line 56 to the XEBEC circuit. Upstream data is output on line 58 from the XEBEC circuit 18 to the transceiver 24 for forward error correction encoding, interleaving, spectrum spreading and trellis code modulation and equalization filtering. In some legacy modems, not all these functions are performed, but there will usually be some encoding with parity bits and there will always be mapping of the payload data and parity bits into constellation points.

I²C control data on line 60 controls tuning by the tuner 36 to the selected channel, and I²C control data on line 62 controls transmit power of amplifier 34.

Light emitting diodes 64 provide status information, and external power supply 66 converts 120 volts AC to a suitable DC voltage. Power supply filtering and regulation and conversion to the various voltages needed by the various circuits is performed by the regulator circuit 68. A power on reset circuit 70 resets all circuitry when the power comes on and senses a power loss.

The preferred embodiment of the invention contemplates using a DOCSIS 2.0 compatible circuit (not shown), preferably integrated, and companion flash memory and DRAM memory (not shown) as a substitute for the circuits in FIG. 1 which have a dot in their upper left corners. Specifically, the DOCSIS 2.0 compatible integrated circuit will include circuitry that performs the functions of the XEBEC circuit 18, transceiver 24, TACO chip 48, DQU circuit 28 and the amplifier 46 but in a DOCSIS 2.0 compatible way.

Any DOCSIS 2.0 compatible circuitry, whether integrated into one package or as so-called “glue logic” on a printed circuit board which can perform the functions of the XEBEC circuit 18, transceiver 24, TACO chip 48, DQU circuit 28 and the amplifier 46 in a DOCSIS 2.0 compatible way, and which are substituted for the legacy proprietary, or DOCSIS 1.0 or 1.1 circuits of the target modem, will suffice to practice the invention.

The preferred embodiment of the invention uses a 6130 integrated circuit which is planned to be available shortly from the assignee of the invention to provide the DOCSIS 2.0 compatible circuitry to replace the XEBEC circuit 18, transceiver 24, TACO chip 48, DQU circuit 28 and the amplifier 46 of the target modem. Some RF tuners 36 will output different IF frequencies than are typically output by DOCSIS 1.0 and 1.1 tuners. The 6130 is programmable to do IF sampling to convert whatever IF frequency exists on line 44 to baseband for processing by the transceiver circuitry in the 6130. In some embodiments, the Ethernet PHY chip 14 will also be replaced by the Ethernet PHY circuitry in the 6130 integrated circuit although this is not preferred. The 6130 integrated circuit is a chip that goes into the planned Terayon DOCSIS 2.0 compatible cable modem and is not a circuit that is built specially for this refurbishment invention. In other words, it would have existed anyway to build brand new DOCSIS 2.0 compatible modems, so it is used for the additional purpose of refurbishing legacy proprietary and DOCSIS 1.0 and 1.1 modems to reduce the cost of generating new DOCSIS 2.0 compatible modems. Another embodiment uses the Terayon 6030 DOCSIS 2.0 compatible integrated circuit plus another DQU integrated circuit and (the 6030 does not have a DQU or Ethernet PHY circuit built in whereas the 6130 does have an on-board DQU and will have an Ethernet PHY) plus flash and DRAM memory chips as the replacement DOCSIS 2.0 compatible circuits to replace the obsolete circuits with the dot on them in FIG. 1.

To the extent that the target modem does not have circuitry in the form of the XEBEC circuit 18, transceiver 24, TACO chip 48, DQU circuit 28 and the amplifier 46, but has other circuitry which performs legacy proprietary SCDMA functions or DOCSIS 1.0 or DOCSIS 1.1 functions (hereafter referred to as “obsolete circuits”) which are also performed in a DOCSIS 2.0 compatible way by circuits in the DOCSIS 2.0 compatible circuit, those obsolete circuits are replaced by the DOCSIS 2.0 compatible circuit.

Refurbishment allows the following circuits of the legacy proprietary or DOCSIS 1.0 or 1.1 target modem to be re-used after the rework: the enclosure; the external power supply 66, the regulator 68, the power on reset circuit 70, the LEDs and connectors 64, the tuner 36, the surface acoustic wave filter 42, the power amplifier 34, the low pass filter 32, the magnetics 12, the surge protection circuits that protect the circuitry in case of a power surge on the Ethernet or HFC medium (not shown but located on the Ethernet connectors and in the tuner 36), the discrete bypass and other capacitors and resistors and inductors if any on the target modem PCB, and the cables. There may also be a delta savings in labor in building and attaching only the replacement circuitry PCB versus building an entire DOCSIS 2.0 compatible PCB and modem. There will also be a delta saving in cost for fabricating the smaller replacement circuitry PCB as compared with having to make an entire PCB for a DOCSIS 2.0 compatible modem from scratch. There may also be savings in testing by not having to repeat tests that have already been performed and there will also be savings by leveraging existing test equipment with perhaps some minor modifications to test DOCSIS 2.0 circuitry.

Replacement of the obsolete circuits in the target modem by the DOCSIS 2.0 compatible circuits can be implemented in any way. The preferred way is to use an integrated circuit that has all of the DOCSIS 2.0 compatible circuits except for the flash and DRAM memories integrated thereon. This integrated circuit and companion flash and DRAM memory chips are then substituted for the obsolete circuits by breaking the conductive traces on the printed circuit board (PCB) of the target modem at appropriate places and connecting the appropriate connection points on the PCB to the appropriate connection points of the DOCSIS 2.0 compatible circuit(s). Typically this is done by removing the XEBEC chip 18 and the flash and DRAM memories 20 and 22, and attaching a PCB supporting the DOCSIS 2.0 compatible circuits and companion memory chips to the PCB of the target modem at the now vacant location of the XEBEC chip. Wires are then soldered from the appropriate connection pads on the DOCSIS 2.0 compatible circuit PCB to the appropriate connection points on the target modem PCB.

Other embodiments can use a single integrated circuit that includes all the DOCSIS 2.0 circuitry needed to replace the replaced obsolete circuitry plus the flash and DRAM memory. This chip will be soldered onto a replacement PCB which is supported at the location on the target modem PCB where the XEBEC or equivalent circuitry was removed. Connection pads on the replacement PCB will then be connected to the appropriate pins of the chip and wires will be soldered between these connection pads and the appropriate connection points on the PCB of the target modem.

Other embodiment will use a replacement PCB. The replacement PCB is a small replacement printed circuit board which has the 6130 or 6030 integrated circuit (or equivalent chips) mounted thereon along with all necessary companion chips such as flash memory and DRAM, an auxiliary voltage regulator to supply any new voltage levels that the 2.0 circuitry needs that the target modem voltage regulator does not supply, an IF amplifier if necessary, and a DQU if a 6030 is used.

Other embodiments will use a multi-chip module (MCM). An MCM has a single integrated circuit support on which are mounted integrated circuit die that do all the necessary DOCSIS 2.0 functions recited above. The integrated circuit die are glued to the substrate mechanically, and then wire bonds to connection pads are made to complete the circuit. Specifically, there will be mounted on the MCM integrated circuit support integrated circuit die which do the functions of the 6130 or 6030 integrated circuit (or equivalent chips) along integrated circuit die which do the functions of all necessary companion chips such as flash memory and DRAM, an auxiliary voltage regulator to supply any new voltage levels that the 2.0 circuitry needs that the target modem voltage regulator does not supply, an IF amplifier if necessary, and a DQU if a 6030 is used.

The difference between the replacement PCB and the MCM is on the PCB, prepackaged chips are mounted on the replacement PCB and connected together by the conductive traces on the PCB. On an MCM, bare integrated circuit die are mounted and connected together by wire bonds or other means, and the resulting circuit is then encapsulated in a package that looks like an integrated circuit.

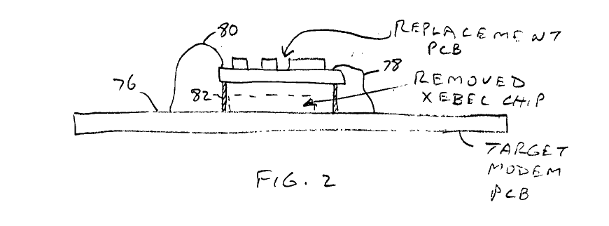

Machinery to fabricate MCMs already exists and can be programmed to make any kind of MCM. FIG. 2 illustrates the piggyback mounting of a replacement PCB 74 on the target modem PCB 76 at the location of the removed XEBEC chip and its memories. Wires 78 and 80 are then soldered between connection pads on the replacement PCB and the appropriate connection points on the target modem PCB. The replacement PCB can be mounted to the target modem PCB by pins such as pin 82 or by any other suitable mechanical mounting means.

The MCM mounting will be similar but the MCM, since it is an integrated circuit type package, would be mounted to a socket on a replacement PCB. The replacement PCB would then be mounted to the target modem PCB as described above for the replacement PCB embodiment, and wires would be soldered between pads on the replacement PCB and the appropriate connection points on the target modem PCB.

In some embodiments, the integrated circuits or the individual integrated circuit die thereof of the DOCSIS 2.0 compliant circuitry (replacement circuits) can be mounted directly to the printed circuit board of the target modem in the location where the obsolete chips were removed. If the die themselves are mounted, the space where the XEBEC chip is removed can be used as the substrate of the MCM itself. Additional connect patterns to interconnect the dies properly would have to be formed on the target modem's PCB board in the location where the XEBEC chip and flash and DRAM memory integrated circuits were removed. This is harder to do because criss-crosses of wire bonded wires are difficult and unreliable, so if criss crosses would be required, an MCM or replacement PCB would be easier to implement.

The circuitry is completed by using any means of connecting the replacement circuits together suitably and any means to connect various predetermined points of said replacement circuit to predetermined points on said printed circuit board of said target modem. Printed circuit board, as that term is used in the claims means not only the board itself but also any integrated circuits and discrete components physically mounted on the printed circuit board and the conductive traces to connect the integrated circuits and discrete components together.

There will usually be a larger flash memory chip and a larger DRAM chip on the replacement circuit board, both coupled to the DOCSIS 2.0 compatible integrated circuit to store program and data for the DOCSIS 2.0 processing in all embodiments. However, in some embodiments where the programs and data required for 2.0 processing can fit into the existing flash and DRAM memory chips in the target modem, those memory circuits 20 and 22 do not have to be replaced.

Further, in some embodiments, extra flash and DRAM chips can be added on the replacement PCB and the existing flash and DRAM can be re-used just by supplementing the address space with additional address lines. This is not preferred because current market conditions actually cause 8 MB DRAM chips to be cheaper than 2 MB chips. However, the concept of the invention is to increase the memory sizes to the needed sizes in whatever way is the cheapest given current market conditions.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A process for refurbishing a cable modem that is not compliant with DOCSIS 2.0 (hereafter the target modem) so that said target modem is transformed into a cable modem that is compliant with DOCSIS 2.0, comprising the steps of:
1) mounting on a printed circuit board all the circuitry of a replacement circuit, said replacement circuit including all integrated circuits needed to perform functions of a cable modem compliant with DOCSIS 2.0;
2) breaking connections on a printed circuit board of said target modem at predetermined points and making suitable connections between said circuitry mounted in step 1 to appropriate predetermined points on said printed circuit board of said target modem so as to re-use circuitry and apparatus of said target modem with said replacement circuit so as to create a cable modem which is compliant with DOCSIS 2.0.

2. The process of claim 1 wherein step 1 comprises creating a replacement printed circuit board with said replacement circuit formed thereon, and mounting said replacement printed circuit board on said printed circuit board of said target modem, and wherein the step of creating said replacement circuit comprises mounting a microprocessor, voltage regulator, flash memory of a suitable size for DOCSIS 2.0 applications, DRAM of a suitable size for DOCSIS 2.0 applications and media access control prepackaged integrated circuits on said replacement printed circuit board and forming conductive traces on said replacement printed circuit board to connect said integrated circuits together suitably to form a circuit which has connection points which when suitably connected to appropriate predetermined points on said printed circuit board of said target modem, makes a cable modem that is compliant with DOCSIS 2.0.

3. The process of claim 1 wherein step 1 comprises creating a replacement printed circuit board and mounting said replacement printed circuit board on said printed circuit board of said target modem, and wherein the step of creating said replacement printed circuit board comprises mounting a multichip module having therein a plurality of integrated circuit die which include a microprocessor, a voltage regulator, a flash memory of a suitable size for DOCSIS 2.0 applications, DRAM of a suitable size for DOCSIS 2.0 applications and media access control integrated circuit die, all mounted on a support structure of said multichip module, said die having connection pads thereon which are suitably electrically connected together to form a circuit which has connection points on said multi-chip module which are connected electrically to connection points on said replacement circuit board, which, when suitably connected to appropriate predetermined points on said printed circuit board of said target modem, makes a cable modem that is compliant with DOCSIS 2.0.

4. The process of claim 1 wherein the step of creating said replacement circuit accomplished in step 1 comprises mounting all the integrated circuits needed to implement said replacement circuit for a DOCSIS 2.0 compliant cable modem on the motherboard of said target modem in the locations where integrated circuits of said target modem are no longer needed and have been removed, and making suitable connections between said integrated circuits of said replacement circuit to form said replacement circuit and forming interconnection pads on said motherboard of said target modem, and wherein step 2 includes making electrical connection between said interconnection pads of said replacement circuit formed on said motherboard to the appropriate sides of said break points.

5. A process for refurbishing target modems to render said target modems compliant with DOCSIS 2.0, comprising the steps:
1) removing a control microprocessor integrated circuit and any other integrated circuits that are needed to implement the media access control protocol of said target modem;
2) physically mounting a replacement printed circuit board at the location where said integrated circuits were removed in step 1, said replacement printed circuit board having mounted thereon and suitably connected all circuitry thereon which is necessary to performs the functions necessary to be compliant with DOCSIS 2.0;
3) breaking connections on a printed circuit board of said target modem at all points necessary to supply signals to circuits on said replacement printed circuit board and to supply signals from circuits on said replacement printed circuit board to circuits or apparatus on said printed circuit board of said target modem so as to cause said circuits on said replacement printed circuit board to perform DOCSIS 2.0 compliant functions and supply signals to the appropriate places on said printed circuit board of said target modem so as to use circuits and apparatus on said printed circuit board of said target modem which can still be used in DOCSIS 2.0 compliant modems;
4) making electrical connections in any way between the predetermined points of circuitry on said replacement printed circuit board and appropriate points on said printed circuit board of said target modem so as to complete the circuitry of a functional DOCSIS 2.0 compliant cable modem.

6. A DOCSIS 2.0 compliant cable modem made from a cable modem which is not compliant with DOCSIS 2.0 (hereafter a target modem), comprising:
a printed circuit board of said target modem, said printed circuit board including an RF tuner, a SAW filter, a power amplifier, a low pass filter, magnetics for a local area network interface, a voltage regulator, a power on reset circuit, surge protectors, various discrete components such as resistors, capacitors and possibly inductors;
an enclosure;
connectors on said enclosure to connect said printed circuit board of said target modem to an Ethernet LAN segment, to a hybrid fiber coaxial cable segment and to a power supply;
an external power supply and wires to connect it to a connector on said enclosure;
light emitting diodes (LED) mounted on said enclosure and connectors to couple said LEDs to said printed circuit board; and
a replacement circuit board having circuitry formed thereon which replaces predetermined circuits of said printed circuit board of said target modem to perform functions of a cable modem in a manner compliant with DOCSIS 2.0, said replacement circuit board physically mounted to said printed circuit board of said target modem and electrically connected to predetermined points of said printed circuit board of said target modem so as to create a cable modem which is compliant with DOCSIS 2.0 and which re-uses said RF tuner, a SAW filter, a power amplifier, a low pass filter, magnetics for a local area network interface, a voltage regulator, a power on reset circuit, surge protectors, various discrete components such as resistors, capacitors and possibly inductors, said enclosure, said connectors, said external power supply, and said LEDs and connectors therefor thereby saving greatly on the expense of fabrication a DOCSIS 2.0 compliant cable modem.
